(19) United States
(12) Patent Application Publication
(10) Pub. No.: US 2025/0245257 A1
(43) Pub. Date: Jul. 31, 2025

(54) STREAMLINED FRAMEWORK NAVIGATION WITH PATH SUMMARIES

(71) Applicant: NVIDIA Corporation, Santa Clara, CA (US)

(72) Inventors: Siddha Ganju, San Jose, CA (US); Akshit Arora, Daly City, CA (US); Anshul Gupta, San Jose, CA (US)

(21) Appl. No.: 18/422,140

(22) Filed: Jan. 25, 2024

(51) Int. Cl. G06F 16/34; G06F 3/04842; G10L 13/08; G10L 15/26

(52) U.S. Cl. CPC G06F 16/345; G06F 3/04842; G10L 13/08; G10L 15/26

(57) ABSTRACT

Disclosed are systems and techniques that may facilitate framework navigation with path summaries. The techniques include generating a first path summary and a second path summary using a large language model (LLM) based on an LLM input, the LLM input comprising a user input and at least a portion of a framework model. The techniques include causing the first path summary and the second path summary to be presented to a user. The techniques include receiving a user interaction indicating a path summary selection. The techniques include performing one or more operations corresponding to the path summary selection.

### TECHNICAL FIELD

At least one embodiment pertains to a system for facilitating framework navigation using machine learning models.

### BACKGROUND

Large language models (LLMs) can be trained to perform various natural language processing (NLP) tasks and may be capable of understanding and generating human-like text at a large scale. LLMs may perform tasks including language translation, text completion, summarization, question-answering, and conversation generation. Machine learning models can be trained to receive audio and output modified audio or text and to receive text and output modified text or audio. For example, a machine learning model may convert audio to text (e.g., automatic speech recognition (ASR), such as speech to text (STT)) or may convert text to audio (e.g., text-to-speech (TTS)).

### BRIEF DESCRIPTION OF DRAWINGS

FIG. 1 is a block diagram of an example computer system that uses path summaries generated using large language models for framework navigation, according to at least one embodiment;

FIG. 2 illustrates an example flow diagram of processing a user request to generate path summaries for framework navigation, according to at least one embodiment;

FIG. 3 is a flow diagram of an example method of generating path summaries for framework navigation, according to at least one embodiment;

FIG. 4 is a flow diagram of an example method of generating path summaries for multi-modal framework navigation, according to at least one embodiment;

FIG. 5 is a flow diagram of an example methods of generating improved path summaries for framework navigation, according to at least one embodiment; and

FIG. 6 is a block diagram of an example computing device suitable for framework navigation using machine learning models, in accordance with at least some embodiments.

### DETAILED DESCRIPTION

Navigating within a framework can be difficult for a user. That framework may refer to a structured collection of rules and/or principles directed to a particular domain and can be the decision tree of an interactive voice response (IVR) system, the rules regarding valid molecular structures, properties of various physical materials and how they interact, or the like. Each framework has certain constraints that must be obeyed. When a user wants to achieve something within the framework, it can be hard to know how to proceed. For example, the user may know the outcome they desire but may not know the best path to take to get there.

Aspects and embodiments of the present disclosure address these and other technological challenges by using a generative artificial intelligence (AI) model—such as a large language model (LLM)—to give a summary of steps that would be taken within a given framework to obtain a particular outcome. For example, in one embodiment, the LLM may be configured to parse a decision tree of an IVR system and summarize the various paths through the tree. In another embodiment, the LLM may be configured to generate one or more paths that may lead to a desired outcome within a given framework (e.g., without violating the constraints of the framework). Based on a user input, the LLM may provide one or more summaries of paths within the framework that align with the user's intent. Each path summary may include a description of the steps that will be taken in the path and an explanation of the end result (e.g., outcome) of taking that path. In some embodiments, the path summary includes a list of steps that will be taken (e.g., numbered list, bulleted list, etc.). In some embodiments, the path summary describes the steps that will be taken in prose (e.g., paragraph format). In some embodiments, the path summary may be represented as a visual graph or a chart that shows what steps the user would take to reach a certain outcome.

As an example, a traditional IVR system may provide the user with some initial options (e.g., “press 1 for help with an existing reservation, press 2 to request a ticket refund, . . . ”). After selecting an option (e.g., 1), the traditional IVR system may provide the user with a second level of options (e.g., “press 1 to check the status of your flight, press 2 to change your reservation, press 3 to cancel your reservation, . . . ”). The IVR system may include additional levels of options. After selecting a final option (e.g., option 3 to cancel the reservation), the traditional IVR system may prompt the user to provide information related to the reservation they would like to cancel (e.g., name, flight number, date of reservation, departure airport, destination airport, etc.). The present disclosure may simplify this process by receiving a user input (e.g., “I would like to cancel my flight”) and generating path summaries using the LLM that describe the different paths the user might take through the IVR system to obtain their desired result. One of the generated path summaries may be “Provide your name and flight number to cancel your reservation.” Responsive to selecting that path summary, the user may be prompted for their name and their flight number, without needing to navigate the different levels/options of the traditional IVR system.

In some embodiments, at least some information about the framework is provided to the LLM along with the user input. For example, the information about the framework that is provided to the LLM may be in the form of a framework model. The framework model may include descriptions of framework constraints, a list of possible outcomes that exist within the framework, and/or the like.

In some embodiments, the path summaries generated by the LLM may be presented to a user, and the user may select one of the path summaries. Based on the user's selection, one or more operations corresponding to the path summary selection may be performed. For example, the user may be prompted to provide additional information that is required in order to achieve the outcome associated with the selected path summary. As an example, the user may select a path summary that ends by rescheduling the user's hotel reservation. After selection of the path summary, the user may be prompted to provide information related to the hotel reservation that the user is trying to change (e.g., name on the reservation, original reservation dates, desired reservation dates, credit card number used for the reservation, etc.).

In some embodiments, the output of the LLM may be restricted (e.g., using model alignment (e.g., guardrails, such as NVIDIA's NeMo Guardrails), post-processing, content filters, etc.) to ensure the user is only presented with valid options for the given framework. For example, after the LLM output has been generated, the LLM output may be analyzed (e.g., by an artificial intelligence (AI) model) to ensure that the outcomes of each path summary in the output are valid for the given framework (e.g., based on the framework information provided to the LLM and/or based on framework information provided to the AI model). Path summaries with invalid outcomes may be modified (e.g., corrected, removed, combined with another path summary, etc.) within the LLM output before the output is presented to a user.

The advantages of the disclosed techniques include but are not limited to allowing a user to quickly navigate within a framework. By providing path summaries to the user based on the user's request, the user can quickly determine which path to follow through the framework to obtain their goal. This can reduce the number of user interactions needed to achieve their desired outcome, thereby conserving computing resources and time.

### System Architecture

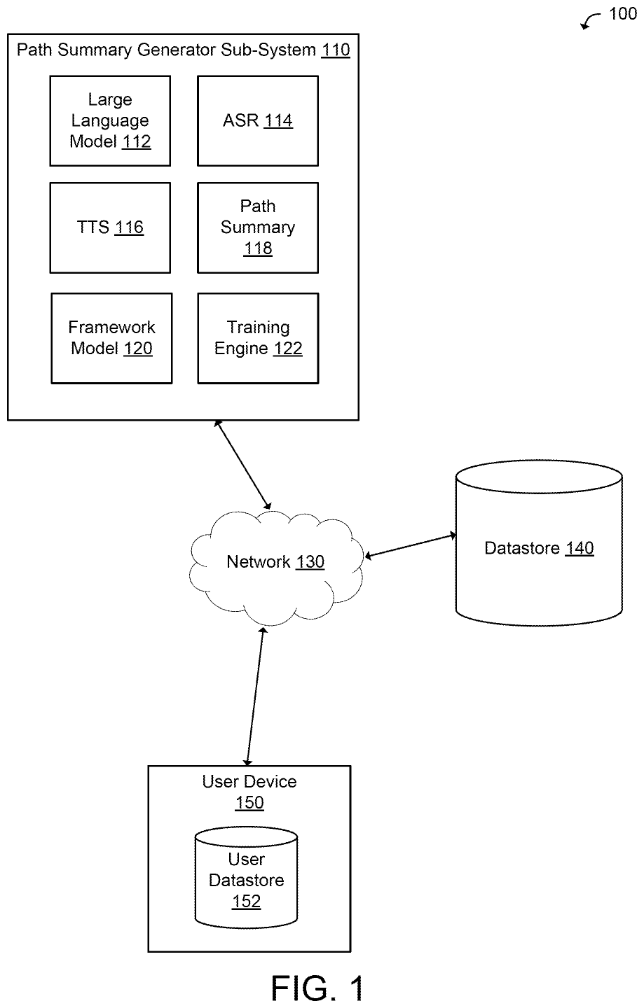

FIG. 1 is a block diagram of an example computer system 100 that provides path summaries 118 generated using large language models 112 for framework navigation, according to at least one embodiment. In some embodiments, system 100 may include path summary generator sub-system 110, datastore 140, and user device 150 connected to a network(s) 130. Network(s) 130 may be a public network (e.g., the Internet), a private network (e.g., a local area network (LAN), or wide area network (WAN)), a wireless network, a personal area network (PAN), another network type, and/or a combination thereof.

Path summary generator sub-system 110 may include a desktop computer, a laptop computer, a smartphone, a tablet computer, a server, a wearable device, a virtual reality (VR)/augmented reality (AR)/mixed reality (MR) headset or heads up display, a digital avatar or chat bot kiosk, an in-vehicle infotainment computing device, and/or any suitable computing device capable of performing the techniques described herein. Path summary generator sub-system 110 may include one or more AI models, including large language model (LLM) 112, automatic speech recognition (ASR) model 114, and text-to-speech (TTS) model 116. Path summary generator sub-system 110 may be configured to use LLM 112 to give a summary of steps (e.g., path summary 118) that would be taken within a given framework to obtain a particular outcome.

The AI models of path summary generator sub-system 110 may include one or more of decision trees, random forests, support vector machines, or other types of machine learning models. In one embodiment, such AI models may include one or more artificial neural networks (also referred to simply as a neural network). The artificial neural network can include a feature representation component with a classifier or regression layers that map features to a target output space. The artificial neural network may be, for example, a convolutional neural network (CNN) that can include a feature representation component with a classifier or regression layers that map features to a target output space, and can host multiple layers of convolutional filters. Pooling can be performed, and non-linearities may be addressed, at lower layers, on top of which a multi-layer perceptron can be commonly appended, mapping top layer features extracted by the convolutional layers to decisions (e.g., classification outputs). The neural network may further be a deep network with multiple hidden layers or a shallow network with zero or a few (e.g., 1-2) hidden layers. Deep learning may use a cascade of multiple layers of nonlinear processing units for feature extraction and transformation. Each successive layer can use the output from the previous layer as input. In deep learning, each level learns to transform its input data into a slightly more abstract and composite representation.

In some embodiments, the AI models of path summary generator sub-system 110 may include one or more recurrent neural networks (RNNs). An RNN is a type of neural network that includes a memory to enable the neural network to capture temporal dependencies. An RNN is able to learn input-output mappings that depend on both a current input and past inputs. The RNN can address past and future measurements and make predictions based on this continuous measurement information. One type of RNN that may be used is a long short term memory (LSTM) neural network.

The AI models of path summary generator sub-system 110 may include at least one generative AI model, such as an LLM (e.g., LLM 112) allowing for the generation of new and original content. A generative AI model may include aspects of a transformer architecture, or a generative adversarial network (GAN) architecture. Such a generative AI model can use other machine learning models including an encoder-decoder architecture including one or more self-attention mechanisms, and one or more feed-forward mechanisms. In some embodiments, the generative AI model can include an encoder that can encode input textual data into a vector space representation; and a decoder that can reconstruct the data from the vector space, generating outputs with increased novelty and uniqueness. The self-attention mechanism can compute the importance of phrases or words within a text data with respect to all of the text data. A generative AI model can also utilize the previously discussed deep learning techniques, including recurrent neural networks (RNNs), convolutional neural networks (CNNs), or transformer networks. A generative AI model can be pre-trained on a large corpus of data so as to process, analyze, and generate human-like text based on given input. Any of the AI models may have any typical architecture for LLMs, including one or more architectures as seen in Bidirectional Encoder Representations from Transformers (BERT), Generative Pre-trained Transformer series (Chat GPT series LLMs), or leverage a combination of transformer architecture with pre-trained data to create coherent and contextually relevant text. In some embodiments, LLM 112 may be any trained LLM capable of performing text summarization and text generator (e.g., GPT-3, GPT-3.5, GPT-4, BERT, RoBERTa, Megatron, etc.).

In some embodiments, ASR 114 may be a CNN and may include an RNN. In some embodiments ASR 114 may be an RNN-based sequence-to-sequence network. In some embodiments, TTS 116 may include an RNN or a Transformer-based model to encode the input text, a deep neural network or CNN for learning the mapping between the encoded text and acoustic representations, and an autoregressive waveform generator or a vocoder to generate the speech waveform from the predicted acoustic features.

For example, in one embodiment, LLM 112 may be configured to parse a decision tree of an IVR system and summarize the various paths through the tree. In another embodiment, LLM 112 may be configured to generate one or more paths that may lead to a desired outcome within a given framework (e.g., without violating the constraints of the framework). Based on a user input (e.g., from user device 150), LLM 112 may provide one or more summaries of paths 118 within the framework that align with the user's intent.

In some embodiments, the user input is text (e.g., from a chatbot dialogue) which may be included as part of the input to LLM 112. In some embodiments, the user input is audio (e.g., from a phone call) that may be provided to ASR 114 to convert the audio to text. The resulting text may be included as part of the input to LLM 112. In some embodiments, it is desirable for path summary 118 to be audio instead of text, so LLM 112 may generate one or more path summaries 118 that may be provided to TTS 116 to convert the text to speech. The resulting speech audio may be presented to a user as a path summary 118. In some embodiments, a multi-modal interaction may occur that uses text and audio. For example, a user may place a phone call and begin an interaction with path summary generator sub-system 110. Path summary generator sub-system 110 may send the user's phone (e.g., user device 150) a message (e.g., short message service (SMS) message, multimedia message service (MMS) message, push notification, etc.) to provide text information to the user (e.g., the text output of the LLM). In some embodiments, the text information may include path summary 118. The user may speak to select one of the outcomes based on the information received in the message. For example, each path summary 118 may include an associated name or number (as defined in the message provided to the user), and the user may speak the name or number of the desired path summary to select the corresponding path summary.

Each path summary 118 may include a description of the steps that will be taken in the path and an explanation of the end result (e.g., outcome) of taking that path. In some embodiments, path summary 118 includes a list of steps that will be taken (e.g., numbered list, bulleted list, etc.). In some embodiments, path summary 118 describes the steps that will be taken in prose (e.g., paragraph format). In some embodiments, path summary 118 may be represented as a visual graph or a chart that shows what steps the user would take to reach a certain outcome.

In some embodiments, at least some information about the framework (e.g., framework model 120) is provided to LLM 112 along with the user input. Framework model 120 may include descriptions of framework constraints, a list of possible outcomes that exist within the framework, and/or the like.

Datastore 140 may include a persistent storage capable of storing path summaries 118, framework models 120, training data, and/or the like. Datastore 140 may be hosted by one or more storage devices, such as main memory, magnetic or optical storage disks, tapes, or hard drives, network-attached storage (NAS), storage area network (SAN), and so forth. Although depicted as separate from path summary generator sub-system 110, in at least some embodiments, datastore 140 may be a part of path summary generator sub-system 110. In at least some embodiments, datastore 140 may be a network-attached file server, while in other embodiments datastore 140 may be some other type of persistent storage such as an object-oriented database, a relational database, and so forth, that may be hosted by a server machine or one or more different machines coupled to path summary generator sub-system 110 via network(s) 130.

In some embodiments, path summary generator sub-system 110 may be hosted by one or more servers. For example, LLM 112, ASR 114, and TTS 116 may be hosted by a first server while path summary 118, framework model 120, and training engine 122 may be hosted by a second server. In some embodiments, each component of path summary generator sub-system 110 may be hosted by a different server. The one or more servers hosting path summary generator sub-system 110 may be connected via a network (e.g., network(s) 130).

In some embodiments, path summary generator sub-system 110 may be connected to multiple user devices (e.g., via network(s) 130) and may include multiple AI models. For example, path summary generator sub-system 110 may include different AI models for individual user devices and/or different AI models for individual groups of users (e.g., communities, organizations, etc.).

In some embodiments, training engine 122 of path summary generator sub-system 110 may be used to train and/or retrain LLM 112. In some embodiments, training engine 122 may be a separate system or sub-system separate from path summary generator sub-system 110. In some embodiments, path summary generator sub-system 110 may be hosted by a user device, and training engine 122 may be hosted by one or more servers separate from the user device.

Training engine 122 may use training data (e.g., stored in datastore 140) obtained from user interactions with path summary generator sub-system 110 to improve an accuracy of the results of LLM 112. In some embodiments, training data originating from multiple user devices may be used to improve an accuracy of the results of LLM 112. Training data may include user inputs (e.g., user requests) and corresponding selected path summaries. For example, the user input may be used as an input with the path summary selected by the user used as the ground-truth target output for LLM 112. In some embodiments, training data may include user feedback indicating the usefulness of a particular path summary. Improved path summaries may include path summaries that better align (e.g., based on one or more alignment scores) with the framework that is being navigated. For example, the improved path summaries may more accurately represent valid paths through the framework, may more accurately represent valid outcomes available within the framework, etc.

User device 150 may include a desktop computer, a laptop computer, a smartphone, a tablet computer, a server, a wearable device, a virtual reality (VR)/augmented reality (AR)/mixed reality (MR) headset or heads up display, a digital avatar or chat bot kiosk, an in-vehicle infotainment computing device, and/or any suitable computing device capable of performing the techniques described herein. User device 150 may interact with path summary generator sub-system 110 (e.g., via network(s) 130) and may provide a user input to path summary generator sub-system 110. The user input may be combined with framework model 120 (or a portion thereof) to create an LLM input to be provided to LLM 112. LLM 112 may generate one or more path summaries 118 and may provide the one or more path summaries to user device 150. User device 150 may provide a path summary selection to path summary generator sub-system 110. Path summary generator sub-system 110 may perform one or more operations corresponding to the path summary selection.

In some embodiments, user device 150 includes user datastore 152. User datastore 152 may be some type of persistent storage such as an object-oriented database, a relational database, and so forth for storing user-specific context information. The user-specific context information may include the user's input to LLM 112, answers provided by the user during one or more question-answer interactions with path summary generator sub-system 110, the path summary selected by the user, and/or the like. In order to preserve the privacy of potentially sensitive user-specific context information, the user-specific context information stored in user datastore 152 may not be used to train and/or re-train LLM 112.

### Generating Path Summaries for Framework Navigation

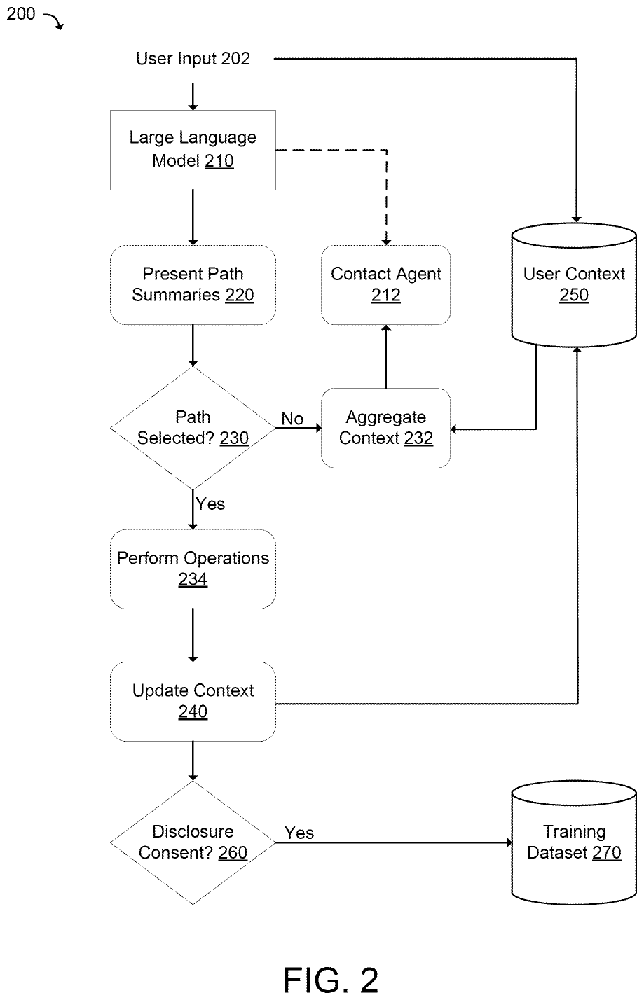

FIG. 2 illustrates an example flow diagram 200 of processing a user request to generate path summaries for framework navigation, according to at least one embodiment. User input 202 may be provided to large language model (LLM) 210 (e.g., LLM 112 of FIG. 1). In some embodiments, user input 202 is also provided to user context 250 (e.g., user datastore 152 of FIG. 1). LLM 210 may generate one or more path summaries based on user input 202. In some embodiments, user input 202 is combined with at least a portion of a framework model that describes the framework that the user is navigating. For example, the framework model may include descriptions of framework constraints, a list of possible outcomes that exist within the framework, and/or the like. In some embodiments, the output of LLM 210 may be restricted (e.g., using guardrails, post-processing, content filters, etc.) to ensure the user is only presented with valid options for the given framework. In some embodiments, LLM 210 may provide path summaries for the top N outcomes that match the user's intent.

At 220, the one or more path summaries generated by LLM 210 may be presented. Each path summary may include a description of the steps that will be taken if the path is selected and an explanation of the end result (e.g., outcome) of selecting that path. In some embodiments, each path summary includes a list of steps that will be taken (e.g., numbered list, bulleted list, etc.). In some embodiments, each path summary describes the steps that will be taken in prose (e.g., paragraph format). In some embodiments, each path summary may be represented as a visual graph or a chart that shows what steps the user would take to reach a certain outcome.

At block 230, if the user does not select one of the presented path summaries, at block 232, context information related to the interaction may be aggregated. For example, the user's input (e.g., from user context 250) and the one or more path summaries that were presented to the user may be combined to create the context information. At block 212, the user may be put in contact with a human agent and at least a portion of the context information may be provided to the human agent. In some embodiments, if LLM 210 is not able to find a suitable outcome within the framework based on the user's request (e.g., user input 202) or if LLM 210 determines that the user's intent is to speak to a human agent directly (e.g., instead of performing a series of actions to obtain an outcome), following the dashed-line arrow, the user may be directed immediately to a human agent that can assist the user (e.g., before being presented any path summaries).

At block 230, the user may select one of the path summaries presented by LLM 210. Based on the user's selection, one or more processes (e.g., operations) may occur at block 234, such as a series of question-answer interactions with the user. For example, if the given framework is that of an IVR system (or similar), the IVR system may proceed through the decision tree, following the path corresponding to the path summary selected by the user. The IVR system may request additional information from the user at one or more steps along the path. At the end of the path, the user may have completed their desired outcome: an outcome corresponding to the path summary they selected. In some embodiments, the user may be given the opportunity to create and submit a new request to the LLM (e.g., based on the information provided in the LLM's response(s)), such that the process described in example flow diagram 200 repeats.

At block 240, context information about a user's interaction may be added to user context 250 (e.g., user datastore 152) saved on the user's device. The context information may include user input 202, answers provided by the user during one or more question-answer interactions, the path summary selected by the user, and/or the like. In some embodiments, at least a portion of the information stored in user context 250 may be included as input to the LLM along with the user's request (e.g., user input 202). For example, during a first interaction, a user might ask for details about an upcoming flight. The user may be presented with one or more path summaries from LLM 210 (e.g., at block 220), one of which might have an outcome of getting flight information. If the user selects that path and provides some flight information (e.g., departure date, departing airport, destination, destination airport, flight number, etc.), that information may be stored in user context 250. Then during a second interaction, flight information from user context 250 may be included as an input to LLM 210 (e.g., along with user input 202) so that if the user asks, “Have my flight details changed?”, LLM 210 has additional context about which path through the decision tree will be the best.

In some embodiments, user context 250 may store identification information or authentication information related to the user. At least some of this information may be provided along with user input 202 to LLM 210 in order to provide context information related to who the user is. In some embodiments, at least some information from user context 250 will be provided to a human agent. For example, if a user starts an interaction, makes a request, and does not feel like any of the outcomes included in the path summaries from LLM 210 will solve their problem, the user may request to speak with a human agent (e.g., at block 230). To avoid needing to repeat their request, context (e.g., the user's most recent input request, path summaries shown to the user that were unsatisfactory, etc.) from user context 250 may be provided to the human agent so the human agent can pick up right where the user left off.

In some embodiments, after reaching the end of the path corresponding to the selected path summary, at block 260, the user may be asked to rate their experience. The rating may be provided to the entity that configured LLM 210 to improve LLM 210 for future interactions. For example, in some embodiments, if the user consents, user input 202 and the selected LLM output (e.g., selected path summary) may be added to training dataset 270 (e.g., datastore 140) to further train and/or finetune LLM 210 (e.g., via training engine 122).

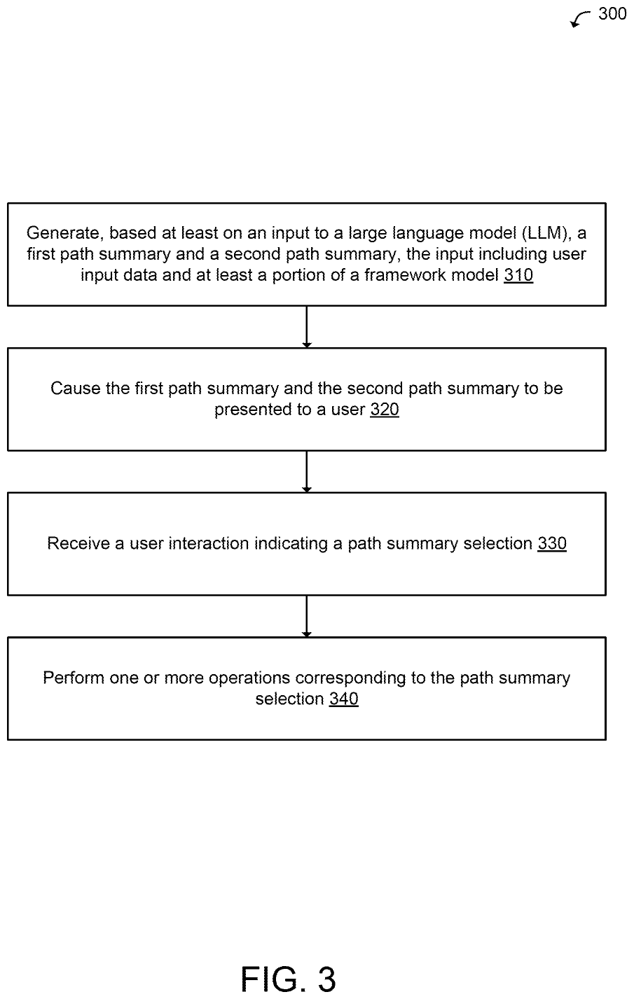

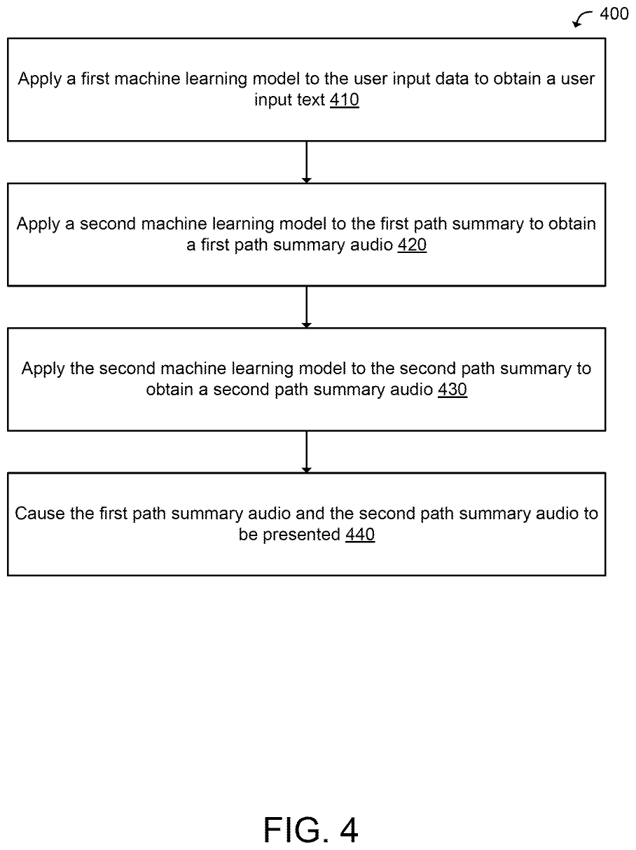

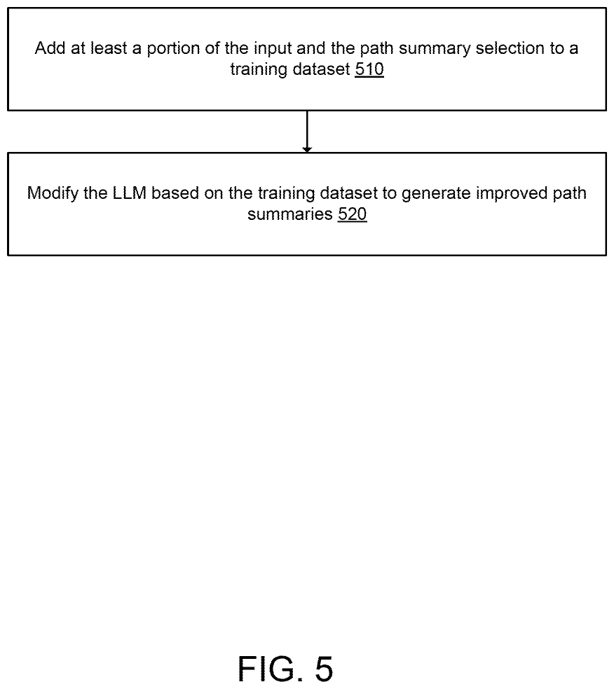

FIGS. 3, 4, and 5 are flow diagrams of example methods 300, 400, and 500 of generating path summaries for framework navigation, generating path summaries for multi-modal framework navigation, and generating improved path summaries for framework navigation, respectively, according to at least one embodiment. Methods 300, 400, and 500 may be performed using one or more processing units (e.g., central processing units (CPUs), graphics processing units (GPUs), accelerators, physics processing units (PPUs), data processing units (DPUs), etc.), which may include (or communicate with) one or more memory devices. In at least one embodiment, methods 300, 400, and 500 may be performed using a processing device. In at least one embodiment, methods 300, 400, and 500 may be performed using processing units of path summary generator sub-system 110 and/or user device 150. In at least one embodiment, processing units performing any of methods 300, 400, and/or 500 may be executing instructions stored on a non-transient computer-readable storage medium. In at least one embodiment, any of methods 300, 400, and/or 500 may be performed using multiple processing threads (e.g., CPU threads and/or GPU threads), individual threads executing one or more individual functions, routines, subroutines, or operations of the method. In at least one embodiment, processing threads implementing any of methods 300, 400, and/or 500 may be synchronized (e.g., using semaphores, critical sections, and/or other thread synchronization mechanisms). Alternatively, processing threads implementing any of methods 300, 400, and/or 500 may be executed asynchronously with respect to each other. Various operations of any of methods 300, 400, and/or 500 may be performed in a different order compared with the order shown in FIG. 3, FIG. 4, and/or FIG. 5. Some operations of any of methods 300, 400, and/or 500 may be performed concurrently with other operations. In at least one embodiment, one or more operations shown in FIG. 3, FIG. 4, and/or FIG. 5 may not always be performed. Methods 300, 400, and 500 may involve data (e.g., user requests, framework models, context data, etc.) related to navigating one or more frameworks using machine learning models.

FIG. 3 is a flow diagram of an example method 300 of generating path summaries for framework navigation, according to some embodiments of the present disclosure. At block 310, processing units executing method 300 may generate, based at least on an input to a large language model (LLM), a first path summary and a second path summary, the input including user input data and at least a portion of a framework model. In some embodiments, the user input data includes text, the first path summary is presented as text, and the second path summary is presented as text. In some embodiments, the user input data includes audio, the first path summary includes text, and the second path summary includes text. In some embodiments, the input further comprises context information related to a user. The context information may be stored on a device of the user. In some embodiments, the context information comprises the user input data, the first path summary, and the second path summary.

At block 320, processing units executing method 300 may cause the first path summary and the second path summary to be presented to a user (e.g., via user device 150 of FIG. 1). At block 330, processing units executing method 300 may receive a user interaction indicating a path summary selection. For example, the user interaction may be received from user device 150. At block 340, processing units executing method 300 may perform one or more operations corresponding to the path summary selection. In some embodiments, the user interaction indicates a request to interact with a human agent, and processing units executing method 300 may provide to the human agent at least a portion of the context information related to the user.

FIG. 4 is a flow diagram of an example method 400 of generating path summaries for multi-modal framework navigation, according to at least one embodiment. At 410, processing units executing method 400 may apply a first machine learning model to the user input data to obtain a user input text. The first machine learning model may be an automatic speech recognition (ASR) model used to convert speech to text. At block 420, processing units executing method 400 may apply a second machine learning model to the first path summary to obtain a first path summary audio. The second machine learning model may be a text-to-speech (TTS) model used to convert an input text to an output speech. At block 430, processing units executing method 400 may apply the second machine learning model to the second path summary to obtain a second path summary audio. At block 440, processing units executing method 400 may cause the first path summary audio and the second path summary audio to be presented. For example, the first path summary audio and the second path summary audio may be presented by user device 150 of FIG. 1. In some embodiments, the first path summary audio and the second path summary audio may be reproduced by user device 150 of FIG. 1.

FIG. 5 is a flow diagram of an example method 500 of generating improved path summaries for framework navigation, according to at least one embodiment. More specifically, method 500 may be used to improve the generation of path summaries for framework navigation. After performing one or more operations corresponding to the path summary selection, at block 510, processing units executing method 500 may add at least a portion of the input and the path summary selection to a training dataset. At block 520, processing units executing method 500 may modify the LLM based on the training dataset to generate improved path summaries. Improved path summaries may include path summaries that better align (e.g., based on one or more alignment scores) with the framework that is being navigated. For example, the improved path summaries may more accurately represent valid paths through the framework, may more accurately represent valid outcomes available within the framework, etc.

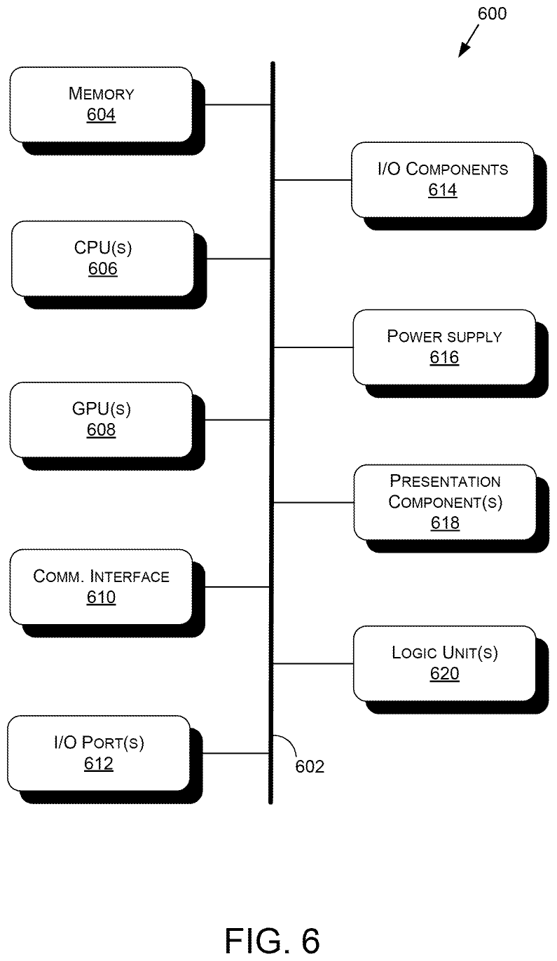

FIG. 6 is a block diagram of an example computing device(s) 600 suitable for framework navigation using machine learning models, in accordance with at least some embodiments. Computing device 600 may include an interconnect system 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, one or more presentation components 618 (e.g., display(s)), and one or more logic units 620. In at least one embodiment, the computing device(s) 600 may comprise one or more virtual machines (VMs), and/or any of the components thereof may comprise virtual components (e.g., virtual hardware components). For non-limiting examples, one or more of the GPUs 608 may comprise one or more vGPUs, one or more of the CPUs 606 may comprise one or more vCPUs, and/or one or more of the logic units 620 may comprise one or more virtual logic units. As such, a computing device(s) 600 may include discrete components (e.g., a full GPU dedicated to the computing device 600), virtual components (e.g., a portion of a GPU dedicated to the computing device 600), or a combination thereof.

Although the various blocks of FIG. 6 are shown as connected via the interconnect system 602 with lines, this is not intended to be limiting and is for clarity only. For example, in some embodiments, a presentation component 618, such as a display device, may be considered an I/O component 614 (e.g., if the display is a touch screen). As another example, the CPUs 606 and/or GPUs 608 may include memory (e.g., the memory 604 may be representative of a storage device in addition to the memory of the GPUs 608, the CPUs 606, and/or other components). In other words, the computing device of FIG. 6 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 6.

The interconnect system 602 may represent one or more links or busses, such as an address bus, a data bus, a control bus, or a combination thereof. The interconnect system 602 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 606 may be directly connected to the memory 604. Further, the CPU 606 may be directly connected to the GPU 608. Where there is direct, or point-to-point connection between components, the interconnect system 602 may include a PCIe link to carry out the connection. In these examples, a PCI bus need not be included in the computing device 600.

The memory 604 may include any of a variety of computer-readable media. The computer-readable media may be any available media that may be accessed by the computing device 600. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 604 may store computer-readable instructions (e.g., that represent a program(s) and/or a program element(s)), such as an operating system. In accordance with one or more aspects of the present disclosure, the computer-readable instructions can comprise executable instructions for executing method 300, method 400, and/or method 500 of generating path summaries for framework navigation. Computer-storage media may include, but is not limited to, random-access memory (RAM), read-only memory (ROM), electronically erasable programmable read-only memory (EEPROM), flash memory or other memory technology, compact disc read-only memory (CD-ROM), digital versatile disks (DVD) or other optical disk storage, magnetic cassettes, magnetic tape, magnetic disk storage or other magnetic storage devices, or any other medium which may be used to store the desired information and which may be accessed by computing device 600. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, radio frequency (RF), infrared and other wireless media. Combinations of any of the above should also be included within the scope of computer-readable media.

The CPU(s) 606 may be configured to execute at least some of the computer-readable instructions to control one or more components of the computing device 600 to perform one or more of the methods and/or processes described herein. For example, in accordance with one or more aspects of the present disclosure, the CPU(s) 606 may be configured to execute instructions executing method 300, method 400, and/or method 500 of generating path summaries for framework navigation. The CPU(s) 606 may each include one or more cores (e.g., one, two, four, eight, twenty-eight, seventy-two, etc.) that are capable of handling a multitude of software threads simultaneously. The CPU(s) 606 may include any type of processor, and may include different types of processors depending on the type of computing device 600 implemented (e.g., processors with fewer cores for mobile devices and processors with more cores for servers). For example, depending on the type of computing device 600, the processor may be an Advanced RISC Machines (ARM) processor implemented using Reduced Instruction Set Computing (RISC) or an x86 processor implemented using Complex Instruction Set Computing (CISC). The computing device 600 may include one or more CPUs 606 in addition to one or more microprocessors or supplementary co-processors, such as math co-processors.

In addition to or alternatively from the CPU(s) 606, the GPU(s) 608 may be configured to execute at least some of the computer-readable instructions to control one or more components of the computing device 600 to perform one or more of the methods and/or processes described herein. One or more of the GPU(s) 608 may be an integrated GPU (e.g., with one or more of the CPU(s) 606) and/or one or more of the GPU(s) 608 may be a discrete GPU. In embodiments, one or more of the GPU(s) 608 may be a coprocessor of one or more of the CPU(s) 606. The GPU(s) 608 may be used by the computing device 600 to render graphics (e.g., 3D graphics) or perform general purpose computations. For example, the GPU(s) 608 may be used for General-Purpose computing on GPUs (GPGPU). The GPU(s) 608 may include hundreds or thousands of cores that are capable of handling hundreds or thousands of software threads simultaneously. The GPU(s) 608 may generate pixel data for output images in response to rendering commands (e.g., rendering commands from the CPU(s) 606 received via a host interface). The GPU(s) 608 may include graphics memory, such as display memory, for storing pixel data or any other suitable data, such as GPGPU data. The display memory may be included as part of the memory 604. The GPU(s) 608 may include two or more GPUs operating in parallel (e.g., via a link). The link may directly connect the GPUs (e.g., using NVLINK) or may connect the GPUs through a switch (e.g., using NVSwitch). When combined together, each GPU 608 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 606 and/or the GPU(s) 608, the logic unit(s) 620 may be configured to execute at least some of the computer-readable instructions to control one or more components of the computing device 600 to perform one or more of the methods and/or processes described herein. In embodiments, the CPU(s) 606, the GPU(s) 608, and/or the logic unit(s) 620 may discretely or jointly perform any combination of the methods, processes and/or portions thereof. One or more of the logic units 620 may be part of and/or integrated in one or more of the CPU(s) 606 and/or the GPU(s) 608 and/or one or more of the logic units 620 may be discrete components or otherwise external to the CPU(s) 606 and/or the GPU(s) 608. In embodiments, one or more of the logic units 620 may be a coprocessor of one or more of the CPU(s) 606 and/or one or more of the GPU(s) 608.

Examples of the logic unit(s) 620 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 610 may include one or more receivers, transmitters, and/or transceivers that enable the computing device 600 to communicate with other computing devices via an electronic communication network, included wired and/or wireless communications. The communication interface 610 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 620 and/or communication interface 610 may include one or more data processing units (DPUs) to transmit data received over a network and/or through interconnect system 602 directly to (e.g., a memory of) one or more GPU(s) 608.

The I/O ports 612 may enable the computing device 600 to be logically coupled to other devices including the I/O components 614, the presentation component(s) 618, and/or other components, some of which may be built in to (e.g., integrated in) the computing device 600. Illustrative I/O components 614 include a microphone, mouse, keyboard, joystick, game pad, game controller, satellite dish, scanner, printer, wireless device, etc. The I/O components 614 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 600. The computing device 600 may be include depth cameras, such as stereoscopic camera systems, infrared camera systems, RGB camera systems, touchscreen technology, and combinations of these, for gesture detection and recognition. Additionally, the computing device 600 may include accelerometers or gyroscopes (e.g., as part of an inertia measurement unit (IMU)) that enable detection of motion. In some examples, the output of the accelerometers or gyroscopes may be used by the computing device 600 to render immersive augmented reality or virtual reality.

The power supply 616 may include a hard-wired power supply, a battery power supply, or a combination thereof. The power supply 616 may provide power to the computing device 600 to enable the components of the computing device 600 to operate.

The presentation component(s) 618 may include a display (e.g., a monitor, a touch screen, a television screen, a heads-up-display (HUD), other display types, or a combination thereof), speakers, and/or other presentation components. The presentation component(s) 618 may receive data from other components (e.g., the GPU(s) 608, the CPU(s) 606, DPUs, etc.), and output the data (e.g., as an image, video, sound, etc.).

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 600 of FIG. 6—e.g., each device may include similar components, features, and/or functionality of the computing device(s) 600.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 600 described herein with respect to FIG. 6. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The systems and methods described herein may be used for a variety of purposes, by way of example and without limitation, for performing one or more operations with respect to systems or methods associated with machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, chat bots, digital avatars, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., an in-vehicle infotainment system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for generating or presenting virtual reality content, mixed reality content, or augmented reality content, systems for performing conversational AI operations, systems for performing light transport simulation, systems for performing collaborative content creation for 3D assets, systems implemented at least partially using cloud computing resources, and/or other types of systems.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, a number of items in a plurality is at least two but can be more when so indicated either explicitly or by context. Further, unless stated otherwise or otherwise clear from context, the phrase “based on” means “based at least in part on” or “based at least on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, in some embodiments, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as a system may embody one or more methods and methods may be considered a system.

In the present document, references may be made to obtaining, acquiring, receiving, or inputting analog or digital data into a subsystem, computer system, or computer-implemented machine. In at least one embodiment, a process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
generating, based at least on an input to a large language model (LLM), a first path summary and a second path summary, the input including user input data and at least a portion of a framework model;
causing the first path summary and the second path summary to be presented to a user;
receiving a user interaction indicating a path summary selection; and
performing one or more operations corresponding to the path summary selection.

2. The method of claim 1, wherein the user input data includes text and the first path summary and the second path summary are presented as text.

3. The method of claim 1, wherein the user input data includes audio and the first path summary and the second path summary include text, the method further comprising:
applying a first machine learning model to the user input data to obtain a user input text;
applying a second machine learning model to the first path summary to obtain a first path summary audio;
applying the second machine learning model to the second path summary to obtain a second path summary audio; and
causing the first path summary audio and the second path summary audio to be presented.

4. The method of claim 1, further comprising:
adding at least a portion of the input and the path summary selection to a training dataset; and
modifying the LLM based on the training dataset to generate improved path summaries.

5. The method of claim 1, wherein the input further comprises context information related to a user and wherein the context information related to the user is stored on a device of the user.

6. The method of claim 5, wherein the context information comprises:
the user input data;
the first path summary; and
the second path summary.

7. The method of claim 5, wherein the user interaction indicates a request to interact with a human agent, the method further comprising:
providing to the human agent at least a portion of the context information related to the user.

8. A system comprising:
one or more processors to:
generate, based at least on a large language model (LLM) input, a first path summary and a second path summary using an LLM, the LLM input comprising a user input and at least a portion of a framework model;
cause the first path summary and the second path summary to be presented to a user;
receive a user interaction indicating a path summary selection; and
perform one or more operations corresponding to the path summary selection.

9. The system of claim 8, wherein the user input is text and the first path summary and the second path summary are text.

10. The system of claim 8, wherein the user input is audio and the first path summary and the second path summary are text, the one or more processors further to:
apply a first machine learning model to the user input to obtain a user input text;
apply a second machine learning model to the first path summary to obtain a first path summary audio;
apply the second machine learning model to the second path summary to obtain a second path summary audio; and
cause the first path summary audio and the second path summary audio to be reproduced.

11. The system of claim 8, the one or more processors further to:
add at least a portion of the LLM input and the path summary selection to a training dataset; and
modify the LLM based on the training dataset to generate improved path summaries.

12. The system of claim 8, wherein the system is comprised in at least one of:
an in-vehicle infotainment system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system for generating or presenting at least one of virtual reality content, mixed reality content, or augmented reality content;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.

13. The system of claim 8, wherein the LLM input further comprises context information related to a user and wherein the context information related to the user is stored on a device of the user.

14. The system of claim 13, wherein the context information comprises:
the user input;
the first path summary; and
the second path summary.

15. The system of claim 13, wherein the user interaction indicates a request to interact with a human agent, the one or more processors further to:
provide to the human agent at least a portion of the context information related to the user.

16. One or more processors to perform operations comprising:
generating a first path summary and a second path summary using a large language model (LLM) based on an LLM input, the LLM input comprising a user input and at least a portion of a framework model;
causing the first path summary and the second path summary to be presented to a user;
receiving a user interaction indicating a path summary selection; and
performing one or more operations corresponding to the path summary selection.

17. The one or more processors of claim 16, wherein the user input is text and the first path summary and the second path summary are text.

18. The one or more processors of claim 16, wherein the user input is audio and the first path summary and the second path summary are text, the operations further comprising:
applying a first machine learning model to the user input to obtain a user input text;
applying a second machine learning model to the first path summary to obtain a first path summary audio;
applying the second machine learning model to the second path summary to obtain a second path summary audio; and
causing the first path summary audio and the second path summary audio to be reproduced.

19. The one or more processors of claim 16, the operations further comprising:
adding at least a portion of the LLM input and the path summary selection to a training dataset; and
modifying the LLM based on the training dataset to generate improved path summaries.

20. The one or more processors of claim 16, wherein the LLM input further comprises context information related to a user and wherein the context information related to the user is stored on a device of the user.
